(19) United States
(12) Patent Application Publication
(10) Pub. No.: US 2006/0249244 A1
(43) Pub. Date: Nov. 9, 2006

(54) Method for producing environmental friendly artificial leather product

(75) Inventors: Ching-Tang Wang, Sungshan Chiu (TW); Mong-Ching Lin, Yancheng Chiu (TW); Chung-Chih Feng, Sanmin Chiu (TW); Pei-Huo Huang, Nantz Chiu (TW); Yong-Song Lin, Dashe Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co. LTD., Jenwu Shiang (TW)

(21) Appl. No.: 11/486,542

(22) Filed: Jul. 14, 2006

Related U.S. Application Data
(63) Continuation-in-part of application No. 10/754,295, filed on Jan. 9, 2004.

(51) Int. Cl. B44C 1/17; B32B 37/00

(52) U.S. Cl. 156/239; 156/289; 156/230; 156/331.7

(57) ABSTRACT

A method for producing an environmental friendly artificial leather product includes coating a first solvent-free elastomer resin composition on a releasing paper to form a top layer, coating a polyurethane resin composition containing more than 50% by weight solid content on the top layer to form an intermediate layer, coating a second solvent-free elastomer resin composition on the intermediate layer to form an adhesive layer, and finally applying a substrate on the adhesive layer, and peeling the releasing paper.

### CROSS REFERENCE TO RELATED APPLICATION

This is a continuation-in-part application of U.S. patent application Ser. No. 10/754,295 filed Jan. 9, 2004, which is now abandoned.

### BACKGROUND OF THE INVENTION

1. Field of the Invention

The present invention relates to a method for producing an environmental friendly artificial leather product and environmental friendly artificial leather product made therefrom.

2. Description of the Related Art

A conventional method for producing genuine-like artificial leather as shown in FIG. 1 comprises two main processes, one being a dry process 100 and other being a wet process 101. The dry process 100 comprises two main steps 102 and 104, i.e., coating a dry polyurethane resin composition on a releasing paper to form a layer of dry polyurethane resin having a thickness ranging from 0.02 mm to 0.03 mm (step 102) and then coating a polyurethane resin composition for adhesion on the dry polyurethane resin layer to form an adhesive layer having a thickness ranging from 0.04 mm to 0.05 mm (step 104). The wet process 101 comprises four main steps 106 to 114, i.e., immersing a substrate into a polyurethane resin composition for immersion to form a immersion layer (step 106), coating a polyurethane resin composition for coating on the substrate to form a coagulating layer (step 110), and washing the coagulating layer (step 112) and then dry to form a foaming layer on the substrate. Finally, the product obtained from the dry process is bonded with its adhesive layer to the foam layer of the product obtained from the wet process (step 114). After peeling the releasing paper (step 116), genuine-like artificial leather is obtained.

However, the dry polyurethane resin and the polyurethane resin for adhesion involved in the dry process or the polyurethane resin for immersion and polyurethane resin for coating involved in the wet process contain a considerable amount of organic solvents, for example methyl ethyl ketone (MEK), dimethyl formamide (DMF), and toluene. When forming the dry polyurethane resin layer or curing the adhesion layer, a drying step is required to completely remove organic solvents in the compositions. It is required to replace the organic solvents contained in the immersion layer and foaming layer with water so that the organic solvents are dissolved in water and then recovered in recovery installations. The organic solvents are inflammable and easy to induce fire accidents. The organic solvents are also toxic which not only induce hazard to human bodies but also cause environmental pollution.

Nowadays, in order to solve pollution problems, the water borne polyurethane resin layer applied to a releasing paper is directly applied to a non-woven fabric or fabric. However, the artificial leather obtained does not provide thickness and flexibility properties similar to those of genuine leathers. Hence, the artificial leather provides neither good hand touch, bending nor thickness properties. Furthermore, to improve the hand touch of the artificial leather based on water borne polyurethane resin layer, water borne polyurethane resin layer applied to releasing papers have been directly applied to wet semi-products of artificial leather having foaming layers. However, the preparation of wet semi-products of artificial leather (referring to wet process 101) still requires a considerable amount of organic solvents. Although the preparation of the surface layer of the artificial leather mentioned previously is environmental friendly, the preparation of the inner layer of the wet semi-products of the artificial leather still requires a considerable amount of organic solvents which pollute the environment.

JP 05-117584 discloses a method for applying a polyurethane coating to a leather or fabric substance. Polyol, polyisocyanate, and an elongating agent are ejected along a mixer of a reacting device whose temperature is kept between −20° C. and 60° C. The ejection speed is reduced to slow down the esterifying reaction in the mixer. Pre-polymerization of the components forms a precursor, for polyurethane. The ejecting pressure is controlled below 4 kg/cm² during application on a releasing paper on a belt conveyor, allowing fall expansion of the precursor. The releasing paper is then heated in an oven at 70-180° C. such that the precursor turns into a layer of polyurethane resin with the same viscosity. A substrate is then bonded to the layer of polyurethane resin and then heated to cause curing of the polyurethane resin into artificial leather with high solid content.

However, the reaction must proceed in the mixer, and the application must be carried out after the reaction. Further, the application must be completed within a short period of time (about 300 seconds). And the conventional polyurethane resin can only be used to manufacture lining materials and gloves that are soft and that have poor properties in peeling strength, abrasion, and flexibility.

Therefore, it is the purpose of the present invention to mitigate and/or obviate the drawbacks existing in the prior art in the manner set forth below.

### SUMMARY OF THE INVENTION

Accordingly, it is an objective of this invention to provide a method for producing an environmental friendly artificial leather product wherein the amount of organic solvent used is considerably reduced.

In order to accomplish the above objective, the subject invention provides a method for producing an environmental friendly artificial leather product mainly comprising coating a first solvent-free elastomer resin composition on a releasing paper to form a top layer having a thickness ranging from 0.02 mm to 0.2 mm, coating a layer of polyurethane resin composition having over 50% by weight solid content of polyurethane resin on the top layer to form an intermediate layer having a thickness ranging from 0.2 mm to 3 mm, coating a second solvent-free elastomer resin composition on the intermediate layer to form an adhesive layer, and bonding a substrate having a thickness ranging from 0.5 mm to 3 mm to the adhesive layer and peeling the releasing paper.

The solvent-free elastomer resin composition suitable for the subject invention includes elastomer resin composition containing no or little organic solvent, for example, water-soluble elastomer resin composition and water dispersed elastomer resin composition. During the method of producing the artificial leather, the solvent-free elastomer resin composition would not produce or merely produce a slight amount of organic solvent so that the environment friendly purpose is achieved.

The subject invention is characterized by using the polyurethane resin composition having over 50% by weight solid content of polyurethane resin to form an intermediate layer having a thickness far more than that of the top layer and the adhesive layer. The polyurethane resin composition for forming the intermediate layer has a larger amount of solid content, low viscosity, and a long pot life. Furthermore, the polyurethane resin composition cures quickly after high-temperature reaction. The polyurethane resin composition is firstly deblocked at a high temperature (about 140-170° C.) with a deblocking agent (such as oxime) and then reacts with a cross-linking agent. The polyurethane resin composition having a larger amount of solid content has a relatively small amount of organic solvent and has a thickness, after being dried, similar to that being coated. The polyurethane resin composition can easily form the intermediate layer having a larger thickness and obtain genuine-like thickness and bending property.

Other objectives, advantages, and novel features of the invention will become more apparent from the following detailed description when taken in conjunction with the accompanying drawings.

### BRIEF DESCRIPTION OF THE DRAWINGS

FIG. 1 represents a flowchart for a conventional method for producing artificial leather.

FIG. 2 represents a flowchart for a method of producing an environmental friendly artificial leather product of an embodiment of the subject invention.

FIGS. 3a through 3e are sectional views illustrating a method of producing an environmental friendly artificial leather product of an embodiment of the subject invention.

### DETAILED DESCRIPTION OF THE PREFERRED EMBODIMENT

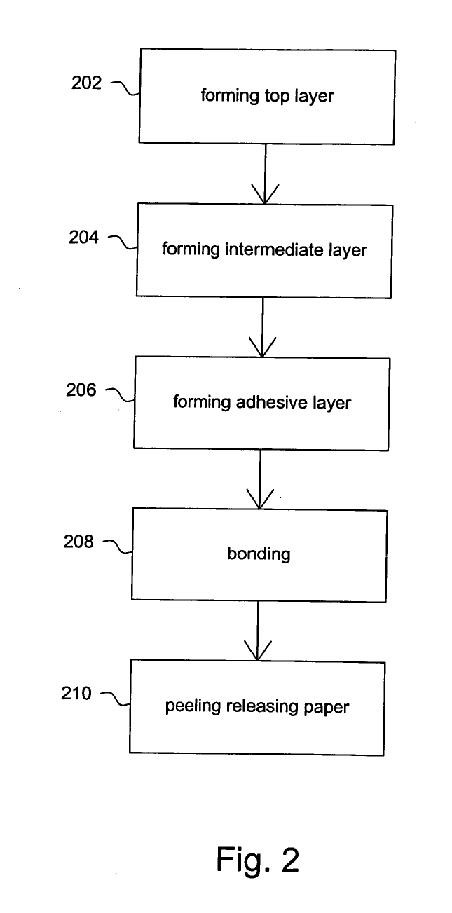

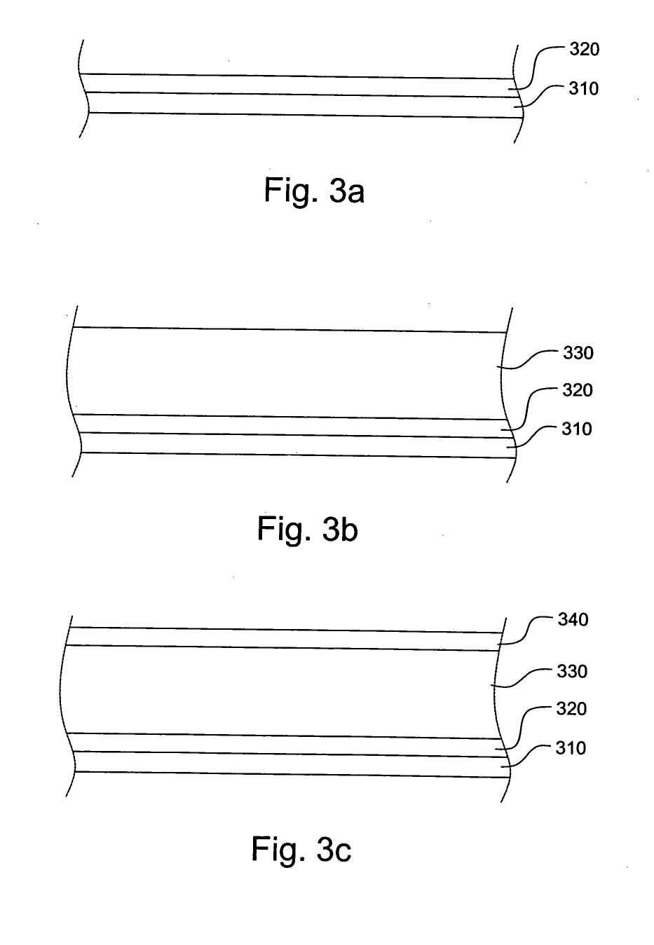

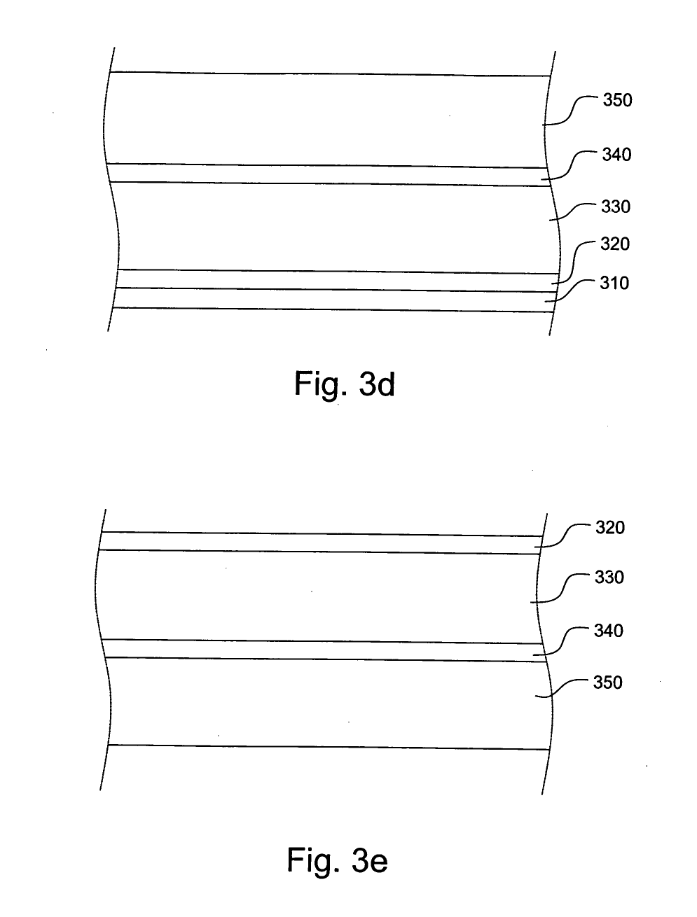

The environmental friendly artificial leather product of the subject invention will be further explained in reference to FIG. 2 and FIGS. 3a to 3e. Firstly, in step 202 (referring to FIG. 3a), a layer of solvent-free elastomer resin composition is coated on a releasing paper 310 to form a top layer 320, after being dried. In step 204 (referring to FIG. 3b), a layer of polyurethane resin composition containing a high solid content is coated on the top layer 320 and dried and cured to form an intermediate layer 330. The polyurethane resin composition for forming the intermediate layer has a larger amount of solid content, low viscosity, and a long pot life. Furthermore, the polyurethane resin composition cures quickly after high-temperature reaction. The polyurethane resin composition is firstly deblocked at a high temperature (about 140-170° C.) with a deblocking agent (such as oxime) and then reacts with a cross-linking agent. Then, in step 206 (referring to FIG. 3c), a layer of solvent-free elastomer resin composition is coated on the intermediate layer to form an adhesive layer 340. Finally, in step 208 (referring to FIG. 3d), a substrate is bonded on the adhesive layer 340. After drying and curing the adhesive layer, in step 210 (referring to FIG. 3e), the releasing paper is peeled to form an environmental friendly artificial leather product. In the text of the invention, “solvent-free elastomer resin composition” means elastomer resin composition containing no or merely a minor amount of organic solvent.

One characteristic of the subject invention resides in the use of the solvent-free elastomer resin composition to form the top layer 320 and adhesive layer 340. The solvent-free elastomer resin composition suitable for forming the top layer 320 includes water soluble elastomer resin composition and water dispersed elastomer resin composition. The solvent-free elastomer resin composition suitable for the adhesive layer 340 includes water-soluble elastomer resin composition, water dispersed elastomer resin composition, and solvent-free wet curing elastomer resin composition. Suitable water dispersed elastomer resin composition includes solvent-free water-soluble polyurethane resin IMPRANIL DLS, available from Bayer CHEM Co. Ltd. Suitable water dispersed elastomer resin composition includes water dispersed polyurethane resin IMPRANIL DLP, available from Bayer CHEM Co. Ltd. The elastomer of the solvent-free elastomer resin composition is selected from the group consisting of polyurethane, polyamino acid and acrylate. In consideration of the hand touch and various physical properties of the environmental friendly artificial leather product, the polyurethane is preferable. During the preparation of the environmental friendly artificial leather product, as the solvent-free elastomer resin composition contains no or merely a minor amount of organic solvent, the forming of the top layer 320 and adhesive layer 340 would not release or merely release a minor amount of organic solvent so that the environmental friendly purpose are achieved.

Solvent-free elastomer resin composition having 10% to 90% by weight of solid content elastomer, preferably 35% to 60% by weight of solid content elastomer, is used to form the top layer 320 having a thickness ranging from 0.02 mm to 0.2 mm after being dried at about 80 to 140° C.

Another characteristic of the subject invention resides in the use of a polyurethane resin composition having a high solid content to form an intermediate layer 330 having a thickness ranging from 0.2 mm to 3 mm, much more than that of the top layer 320 and adhesive layer 340 so as to provide thickness and flexible touch. Polyurethane resin compositions suitable for forming the intermediate layer 330 include preferably 50% by weight of solid content, more preferably at least 98% by weight of solid content. Specifically, polyurethane resin compositions having high solid content contain a relatively minor amount of organic solvent and would not release a considerable amount of organic solvent during the preparation of the intermediate layer 330. The polyurethane resin composition for forming the intermediate layer has a larger amount of solid content, low viscosity, and a long pot life. Furthermore, the polyurethane resin composition cures quickly after high-temperature reaction. The polyurethane resin composition is firstly deblocked at a high temperature (about 140-170° C.) with a deblocking agent (such as oxime) and then reacts with a cross-linking agent. Furthermore, the polyurethane resin composition having a high solid content will have a thickness, after being dried, quite similar to that before drying. It is easy to form a thicker intermediate layer 330 having a thickness, touch and bending properties similar to those of genuine leather. Furthermore, to form an intermediate layer having a better flatness or other properties, the polyurethane resin composition having high solid content can includes 0 to 5% surfactant, 5% to 10% curing agent and 3% to 10% pigment. In accordance with the examples of the subject invention, the polyurethane resin composition having high solid content is dried at a temperature ranging from 110 to 200° C. to form the intermediate layer 330. In addition, a foaming agent can be added to the polyurethane resin composition having a high solid content to form a porous intermediate layer 330. Preferably, the polyurethane resin composition can be subjected to vacuum de-gassing prior to coating.

The substrate 350 can be bonded to the adhesive layer 340 prior to drying the adhesive layer 340 or be bonded to the adhesive layer 340 when the adhesive layer 340 is only slightly dried and is still sticky. Then, an environmental friendly artificial leather semi-product is obtained. Preferably, the environmental friendly artificial leather semi-product is subjected to a curing chamber for about 24 to 48 hours to render the adhesive layer cross-linking. Substrate suitable for the subject invention includes woven fabric, non-woven fabric or animal skin having a thickness ranging from 0.5 mm to 3 mm.

According to the above preparation, the subject invention further provides an artificial leather product shown in FIG. 3e comprising a substrate 350, an adhesive layer 340, an intermediate layer 330 and a top layer 320. The artificial leather product is characterized in that the top layer 320 and adhesive layer 340 is formed of a solvent-free elastomer resin composition and the intermediate layer 320 provided between the top layer 320 and adhesive layer 340 is formed of a polyurethane resin composition containing more than 50% by weight solid content of polyurethane resin. The polyurethane resin composition for forming the intermediate layer has a larger amount of solid content, low viscosity, and a long pot life. Furthermore, the polyurethane resin composition cures quickly after high-temperature reaction. The polyurethane resin composition is firstly deblocked at a high temperature (about 140-170° C.) with a deblocking agent (such as oxime) and then reacts with a cross-linking agent.

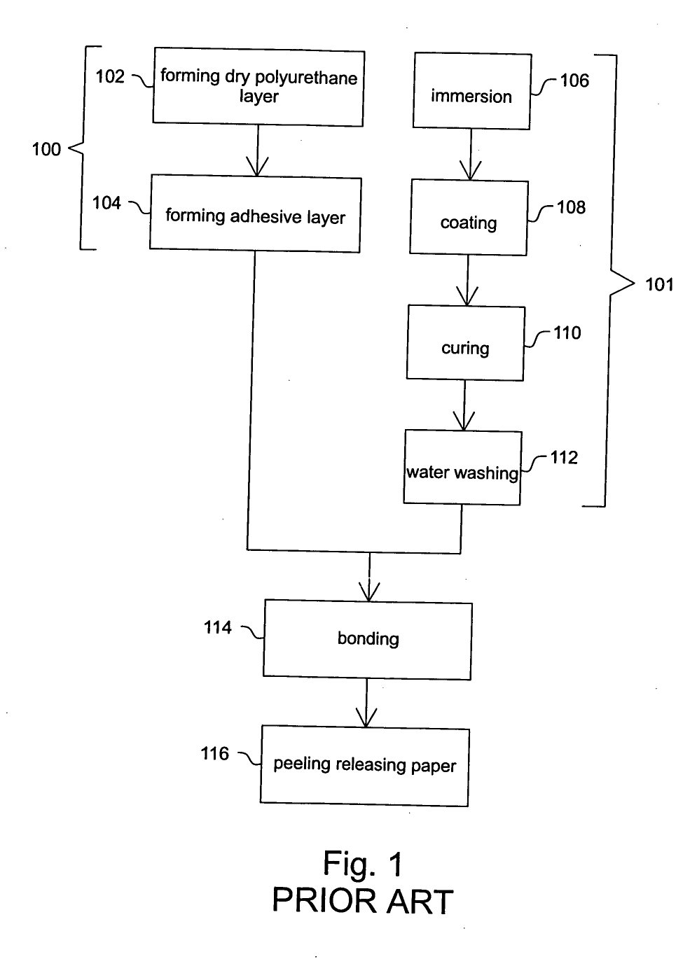

Referring to FIGS. 1 and 2, in addition to environmental friendly effect, the subject invention provides a method of producing an environmental friendly artificial leather product which does not need wet process involved in conventional technique, so as to significantly simplify the procedures of the method of producing artificial leather and increase production yield.

The following examples are to illustrate, rather than to limit, the subject invention.

### EXAMPLE

A releasing paper was coated with a solvent-free polyurethane resin coating having 50% by weight solid content of polyurethane resin and a viscosity of 1300 cps/30° C. The releasing paper was dried in an oven at a temperature of 120° C. to dry the water soluble polyurethane resin coating to become a top layer.

The dried top layer was coated with a polyurethane resin coating having a high solid content. The polyurethane resin coating has a larger amount of solid content, low viscosity, and a long pot life. Furthermore, the polyurethane resin coating cures quickly after high-temperature reaction. The polyurethane resin coating is firstly deblocked at a high temperature (about 140-170° C.) with a deblocking agent (such as oxime) and then reacts with a cross-linking agent. The coating contains polyurethane resin having 98% by weight solid content and additives (surfactant, curing agent and pigments) in a ratio of 5:1 and has a viscosity of 20000±5000 cps/30° C. The polyurethane resin coating having a high solid content on the top layer was dried and cured in an oven at a temperature of 100-160° C. to form an intermediate layer of 0.3-0.5 mm in thickness.

In an example of preparation of the polyurethane resin coating, filling (5-10% by weight) was added into polyurethane resin containing 98% by weight solid content and then stirred for 5 minutes. Then, surfactant (0.5-1.0% by weight), curing agent (5-10% by weight) and pigments (3-6% by weight) are added and stirred to form the polyurethane resin coating having a viscosity of 20000±5000 cps/30° C. that can be kept for at least 4-8 hours.

The cured intermediate layer was coated with a layer of solvent-free polyurethane resin coating having a water borne cross-linking agent therein to form an adhesive layer. The adhesive layer was dried in an oven to slightly dry the solvent-free polyurethane resin coating and allow the adhesive to be sticky. A non-woven fabric having a thickness of 1.0 mm was bonded to the adhesive layer. The adhesive layer was dried in an oven to dry the solvent-free polyurethane resin coating to form an artificial leather semi-product.

The artificial leather semi-product was subjected to a curing step in a curing chamber at a temperature of 50° C. for 24 hours to allow the adhesive layer to have a cross-linking structure. Finally, the releasing paper was peeled from the top layer to result in artificial leather having a thickness touch, high peeling strength, and high bending property.

The artificial leather in accordance with the subject invention was compared with the not environmental friendly products obtained from the conventional method comprising a dry process and a wet process. The comparison is shown in Table 1 as follows:

TABLE 1

| | Product | | |
|---|---|---|---|
| | Not environmental | | |
| | friendly artificial | | Testing |
| | leather product | The subject invention | standard |
| Thickness | 1.3-1.5 mm | 1.3-1.5 mm | ASTM D-1777 |
| Weight | 625-675 g/m² | 670-720 g/m² | ASTM D-3776 |
| Peeling | below 3.2 kg/cm | 3.2-3.5 kg/cm | DIN-53273 |
| strength | | | |
| Flexibility | Qualified for | Qualified for 100000 | DIN-53351 |
| | 100000 cycles | cycles (25° C.) | |
| | (25° C.) | | |
| Abrasion | 2000 cycles | More than | ASTM D-3885 |
| (STOLL) | | 3000 cycles | |
| Tensile | 15 kg/cm | 25 kg/cm | ASTM |
| strength | | | D1682/D1117 |
| Hydrolysis | Jungle test | Jungle test (7 weeks) | ASTM D 3690 |
| | (3 weeks) | | |

Table 1 shows that the artificial leather in accordance with the subject invention has significant improvements in peeling strength, bending and abrasion compared to those of the conventional method involving a considerable amount of organic solvent. The method of the subject invention uses a slight amount or even no organic solvent compared to the conventional method so as to achieve the purposes for human health and environment protection.

It is noted that the polyurethane resin coating may be kept for at least 4-8 hours (the pot life). And it was found that the polyurethane resin can be kept for 3-6 months when the polyurethane resin compositions suitable for forming the intermediate layer 330 include 98% by weight of solid content. Further, the viscosity of the polyurethane resin compositions including 98% by weight of solid content is 10000-70000 cps/25° C. and thus allows direct application. The polyurethane resin compositions in accordance with the present invention can be used to produce artificial leather having excellent properties in peeling strength, abrasion, and flexibility.

The viscosity of polyurethane resin compositions including 80% by weight of solid contents is 100000-150000 cps/25° C. and thus could not allow application (or the application is difficult to carry out). The pot life of the coating is relatively short (about 300 seconds) while the curing procedure thereof is slow. And the conventional polyurethane resin compositions can only be used to manufacture lining materials and gloves that are soft and that have poor properties in peeling strength, abrasion, and flexibility.

While the present invention has been explained in relation to its preferred embodiments and illustrated with various drawings, it is to be understood that the embodiments shown in the drawings are merely exemplary and that various modifications of the invention will be apparent to those skilled in the art upon reading this specification. Therefore, it is to be understood that the invention disclosed herein is intended to cover all such modifications as shall fall within the scope of the appended claims.

What is claimed is:

1. A method for producing an environmental friendly artificial leather product, comprising:
preparing a solvent-free polyurethane resin composition having a pot life of at least three hours at normal temperature, having a viscosity of 20000±5000 cps/30° C., and having 50%-98% of solid content;
coating a first solvent-free elastomer resin composition on a releasing paper to form a top layer,
coating the polyurethane resin composition on said top layer to form an intermediate layer,
coating a layer of a second solvent-free elastomer resin composition on said intermediate layer to form an adhesive layer,
bonding a substrate on said adhesive layer to form an environmental friendly artificial semi-product, and
peeling the releasing paper from said top layer to obtain an environmental friendly artificial leather product.

2. A method for producing an environmental friendly artificial leather product according to claim 1, wherein said first solvent-free elastomer resin composition is a water soluble elastomer resin composition or a water dispersed elastomer resin composition.

3. A method for producing an environmental friendly artificial leather product according to claim 1, wherein said elastomer of said first solvent-free elastomer resin composition is selected from the group consisting of polyurethane, polyamino acid and acrylate.

4. A method for producing an environmental friendly artificial leather product according to claim 1, wherein said first solvent-free elastomer resin composition comprises about 10% to 90% by weight solid content of elastomer.

5. A method for producing an environmental friendly artificial leather product according to claim 1, wherein forming said top layer further comprises drying said first solvent-free elastomer resin composition at a temperature of about 80 to 140° C.

6. A method for producing an environmental friendly artificial leather product according to claim 1, wherein said polyurethane resin composition comprises about 0.5% to 5% by weight of a surfactant and about 5% to 10% by weight of a curing agent.

7. A method for producing an environmental friendly artificial leather product according to claim 1, wherein forming said intermediate layer further comprises drying the polyurethane resin composition.

8. A method for producing an environmental friendly artificial leather product according to claim 1, further comprising subjecting said polyurethane resin composition to vacuum de-gassing prior to coating said polyurethane resin composition.

9. A method for producing an environmental friendly artificial leather product according to claim 1, wherein said second solvent-free elastomer resin composition is a water soluble elastomer resin composition, a water dispersed elastomer resin composition or a solvent-free wet curing elastomer resin composition.

10. A method for producing an environmental friendly artificial leather product according to claim 1, wherein said elastomer of said second solvent-free elastomer resin composition is selected from the group consisting of polyurethane, polyamino acid and acrylate.

11. A method for producing an environmental friendly artificial leather product according to claim 1, wherein said substrate is bonded to said adhesive layer prior to drying said second solvent-free elastomer resin composition.

12. A method for producing an environmental friendly artificial leather product according to claim 1, wherein said substrate is a woven fabric, a non-woven fabric or an animal skin.

13. A method for producing an environmental friendly artificial leather product according to claim 1, further comprising subjecting said artificial leather semi-product to a temperature of about 40 to 60° C. for about 24 to 48 hours to form a cross-linking structure in said adhesive layer prior to peeling said releasing paper.

14. A method for producing an environmental friendly artificial leather product according to claim 1, wherein said polyurethane resin composition comprises 98% by weight solid content of the polyurethane resin.

15. The method for producing an environmental friendly artificial leather product according to claim 1, wherein preparing a solvent-free polyurethane resin composition includes adding a filling, a curing agent, and a deblocking agent into a polyurethane resin having 50%-98% of solid content.

16. A method for producing an environmental friendly artificial leather product according to claim 15, wherein said polyurethane resin composition comprises about 0.5% to 5% by weight of a surfactant and about 5% to 10% by weight of a curing agent.

17. A method for producing an environmental friendly artificial leather product according to claim 15, wherein said polyurethane resin composition comprises 98% by weight solid content of the polyurethane resin.

18. A method for producing an environmental friendly artificial leather product according to claim 16, wherein said polyurethane resin composition comprises 98% by weight solid content of the polyurethane resin.
